(19) United States
(12) Patent Application Publication
(10) Pub. No.: US 2026/0200793 A1
(43) Pub. Date: Jul. 16, 2026

(54) METHOD FOR HYDROPHOBICIZING A GLASS SUBSTRATE

(71) Applicant: SAINT-GOBAIN SEKURIT FRANCE, THOUROTTE (FR)

(72) Inventors: Barbara BRUDIEU, AUBERVILLIERS (FR); Vincent PERROT, AUBERVILLIERS (FR)

(21) Appl. No.: 19/132,181

(22) PCT Filed: Nov. 22, 2023
(86) PCT No.: PCT/EP2023/082657

§ 371 Date: May 22, 2025

(30) Foreign Application Priority Data
Nov. 25, 2022 (FR) 2212350

(51) Int. Cl. C03C 17/42

(52) U.S. Cl. CPC C03C 17/42; C03C 2217/213; C03C 2217/76; C03C 2218/113; C03C 2218/32

(57) ABSTRACT

A method for hydrophobicizing a glass substrate, includes forming a primer layer on one of the main surfaces of the glass substrate, grafting a layer of C₈-C₁₆ alkyltrialkoxysilane and/or C₈-C₁₆ alkyltrichlorosilane onto the primer layer.

The present invention relates to a glass substrate, the surface of which has been rendered hydrophobic by grafting non-fluorinated alkylsilanes, and to a method for manufacturing such a substrate.

Hydrophobic properties are sought for side windows and windscreens in the transport sector, in particular for motor vehicles in which it is essential, for obvious safety reasons, to optimize the transparency of the glazed units even in the event of rain. Raindrops should cling as little as possible to the outer surface of the glazed unit and rather should flow easily under the effect of gravity or aerodynamic flows.

The two parameters used to characterize the hydrophobic nature of the surface of a glazed unit are the contact angle (θ) of a water droplet and the contact angle hysteresis (Δθ).

The hydrophobicity of windows must, of course, withstand abrasion and chemical attack by the environment (water, UV radiation) for as long as possible.

It is known to increase the hydrophobicity of vehicle glazed units by grafting one of the perfluorinated alkylsilanes onto the surface of the glass sheet, generally after prior creation of a silica primer layer by a sol-gel process, magnetron sputtering or chemical vapor deposition (CVD).

However, perfluorinated compounds are considered to be harmful to the environment and human health. The persistent nature of these compounds in the environment and in the human body, combined with their adverse effects on health, has recently increased regulatory pressure regarding their use, notably via the European REACH and POP regulations. This could lead to an extensive ban on these compounds by 2025, or 2030 at the latest.

The aim of the present invention is to propose a method for hydrophobicizing glass substrates, in particular glass substrates which are intended for the automotive industry, which method makes it possible to obtain glazed units having a satisfactory and persistent hydrophobic nature without the use of perfluorinated compounds.

As part of its research with the aim of finding non-toxic molecules that could replace the perfluorinated alkylsilanes that have been used to date for hydrophobicizing glass substrates, the Applicant has tested a large number of hydrophobic functional silanes having hydrocarbon fatty chains.

Almost all the alkylsilanes tested made it possible to achieve satisfactory water droplet contact angles (θ), that is of greater than 90°, or even greater than 95°, and for some even greater than 100°, a hysteresis (Δθ) lower than that obtained after grafting 1H,1H,2H,2H-perfluoroalkyltriethoxysilane (SiF5E), satisfactory resistance to ultraviolet radiation and satisfactory corrosion resistance.

The technical problem encountered was the short lifespan of the hydrophobic coatings prepared in this way. Some of them had insufficient resistance to mechanical abrasion.

The present invention is based on the discovery that alkylsilanes having C₈ to C₁₆ fatty chains, unlike alkylsilanes having shorter or longer hydrocarbon chains, made it possible to produce durable hydrophobic coatings on glass substrates, that is coatings having satisfactory resistance to mechanical abrasion, UV resistance and corrosion resistance.

The present application thus relates to a method for hydrophobicizing a glass substrate, the method comprising the following consecutive steps:
forming a primer layer, preferably of silica, on one of the main surfaces of the glass substrate,
grafting a layer of C₈-C₁₆ alkyltrialkoxysilanes and/or C₈-C₁₆ alkyltrichlorosilanes onto the primer layer.

The present application also relates to a glass substrate obtained by the above method. This hydrophobic glass substrate comprises a transparent glass substrate, which is covered, on one of its main faces, with a primer layer, preferably of silica, said primer layer being grafted with C₈₋₁₆ alkylsilyl groups, preferably linear C₈₋₁₆ alkylsilyl groups.

The glass substrate obtained by the method of the invention is preferably a motor vehicle side window.

According to a first embodiment, the C₈-C₁₆ alkyltrialkoxysilane is an alkyltrialkoxysilane having a linear chain of formula CH₃(CH₂)ₙSiR₃, where n=7-15, preferably n=7-11, and each R represents a C₁₋₃ alkoxy group, preferably a methoxy or ethoxy group.

According to another embodiment, the C₈-C₁₆ alkyltrichlorosilane is an alkyltrichlorosilane of formula CH₃(CH₂)ₙSiR₃, where n=7-15, preferably n=7-11, and each R represents a chlorine atom.

n=7-15 means that n can assume any integer value between 7 and 15, limit values included.

The best results, in particular the best UV resistance and the best salt corrosion resistance, were obtained with a linear C₁₀ alkyl chain (n=9).

In order to obtain good durability of the hydrophobic coating on the glass substrate, it is essential to form a primer layer beforehand on the surface to be treated, preferably a silica primer layer. In order for this primer layer to be effective in anchoring the hydrophobic coating of alkylsilanes on the substrate, it is important for it to comprise as many active silanol groups (Si—OH) as possible, that is groups which are capable of reacting with the silanol groups released by the hydrolysis of the alkoxy functions of the alkyltrialkoxysilane or the chlorine atoms of the alkyltrichlorosilanes. It is also important to ensure that the silica primer layer is sufficiently condensed before deposition of the acidic aqueous-alcoholic solution containing the alkyltrialkoxysilane and/or the alkyltrichlorosilane. This is because, if the silica layer were insufficiently condensed, there would be a risk of it being removed or damaged during the creation of the hydrophobic functional layer.

It is therefore recommended that the grafting of the C₈-C₁₆ alkyltrialkoxysilane or the C₈-C₁₆ alkyltrichlorosilane be carried out after at least 5 minutes' drying of the primer layer at room temperature, preferably 15 minutes. The step of grafting the C₈-C₁₆ alkyltrialkoxysilane and/or the C₈-C₁₆ alkyltrichlorosilane onto the silica primer layer advantageously takes place less than two hours, preferably less than one hour, after this step of drying the primer layer.

Furthermore, it is advisable to carry out a step of polishing the substrate, for example using a felt impregnated with an aqueous suspension of fine abrasive particles, followed by rinsing with water and drying, before the step of forming the primer layer.

The silica primer layer is formed in a sol-gel step wherein a tetrachlorosilane and/or a tetraalkoxysilane, preferably tetraethoxysilane, is hydrolyzed in an acidic aqueous-alcoholic medium.

To implement this step, a suitable quantity of tetrachlorosilane or tetraalkoxysilane is dissolved in a water/alcohol mixture, typically a water/isopropanol mixture, the pH of the water having been previously adjusted to a value between 1 and 3. The content of tetrachlorosilane and/or tetraalkoxysilane in this aqueous-alcoholic solution is advantageously between 0.1 and 1% by weight, preferably between 0.15 and 0.8% by weight. The molar ratio of water to silica precursor, that is to the tetrachlorosilane or tetraalkoxysilane, is generally between 400 and 600, preferably between 450 and 550 and in particular between 480 and 520.

It is preferable not to apply the aqueous-alcoholic solution immediately after dissolving the tetrachlorosilane and/or tetraalkoxysilane, but to allow hydrolysis to take place at room temperature (20-25° C.) for a period of between 30 minutes and 4 hours, preferably between 40 minutes and 3.5 hours, in particular between 45 minutes and 3 hours. During this period, it is advisable to stir the solution in order to ensure good homogeneity of the reaction medium. It is generally not necessary to supply thermal energy to the solution during this hydrolysis step.

In principle, the acidic aqueous-alcoholic solution of the tetraalkoxysilane or tetrachlorosilane can be applied by any technique enabling the formation of a thin liquid film on the surface of the substrate. Mention may be made, by way of example, of application by immersion, curtain coating, spraying or wiping. Use will preferably be made of spraying or nebulizing, and application by means of a cloth soaked in the aqueous-alcoholic solution of tetraalkoxysilane and/or tetrachlorosilane.

After application to the surface of the glass substrate, the liquid film formed is left to dry for a period of at least 5 minutes, preferably at least 15 minutes.

After the first deposit has dried, it is possible to reapply the aqueous-alcoholic solution until the desired silica primer layer thickness is achieved.

The silica primer layer advantageously has a thickness of between 5 nm and 250 nm, preferably between 10 nm and 100 nm, in particular between 15 nm and 75 nm.

Like the formation of the silica primer layer, the step of grafting the alkyltrialkoxysilane and/or alkyltrichlorosilane is carried out by a sol-gel step wherein the alkyltrialkoxysilane and/or alkyltrichlorosilane is hydrolyzed in an acidic aqueous-alcoholic medium. It can be implemented in a similar way to that used for the formation of the primer layer, except that the grafting of the alkyltrialkoxysilane or of the alkyltrichlorosilane is preferably carried out in a single application step.

The grafting composition is an acidic aqueous-alcoholic (water/isopropanol) solution of the C₈-C₁₆ alkyltrialkoxysilane and/or of the C₈-C₁₆ alkyltrichlorosilane. The content of C₈-C₁₆ alkyltrialkoxysilane and/or of C₈-C₁₆ alkyltrichlorosilane in the acidic aqueous-alcoholic solution is preferably between 1 and 4% by weight and in particular between 2.5 and 3.5% by weight, preferably linear C₈-C₁₆ alkyltrialkoxysilane of formula CH₃(CH₂)ₙSiR₃, where n=7-11, and R represents a C₁₋₃ alkoxy group.

The H₂O/C₈-C₁₆ alkyltrialkoxysilane or H₂O/C₈-C₁₆ alkyltrichlorosilane molar ratio of the acidic aqueous-alcoholic solution used for the grafting is between 70 and 200, preferably between 80 and 150, in particular between 90 and 140.

The aqueous-alcoholic solution of C₈-C₁₆ alkyltrialkoxysilane or of C₈-C₁₆ alkyltrialkoxysilane is advantageously left at room temperature for a period of about 30 minutes to about 3 hours, preferably with stirring, to allow hydrolysis of the C₈-C₁₆ alkyltrialkoxysilane or of the C₈-C₁₆ alkyltrialkoxysilane, before being sprayed, sprinkled or wiped onto the glass substrate covered on one of its main faces with the silica primer layer.

In some cases, the inventors encountered a technical problem which was the milky appearance of the alkylsilane deposits obtained. This visual problem was more particularly observed in the case of application by wiping. The treated surface of the glazed units was slightly scattering, thereby unacceptably reducing the transparency and shine of the glazed unit. It was possible to overcome this problem by virtue of a polishing step carried out after the step of grafting the layer of C₈-C₁₆ alkyltrialkoxysilanes and/or C₈-C₁₆ alkyltrichlorosilanes. This polishing step is advantageously carried out by rubbing the surface using a cloth soaked in a solvent, advantageously a mixture of water and alcohol, until specular light reflection is re-established across the entire treated surface. The water/alcohol mixture is preferably a water/isopropanol mixture and contains from 30% to 90% by weight of water, preferably from 50% to 80% by weight of water.

Standard procedures known in the technical field of hydrophobic coatings are used to assess the hydrophobicity of the deposits:

### Contact Angle Measurement:

The contact angle (θ) of a water droplet at equilibrium is measured using a Krüss DSA-100 goniometer (Drop Shape Analyzer) on a 3 μl droplet. The droplet is observed using a high-speed camera, which takes photos from which the contact angle is then recorded. The higher the value of the contact angle, the more hydrophobic is the surface of the sample tested.

### Contact Angle Hysteresis Measurement:

The contact angle hysteresis is also measured using a Krüss DSA goniometer. The apparatus deposits a 5 μl droplet of water on the hydrophobic surface of the sample to be tested. Water is then injected (at a rate of 0.5 μl/min) into the droplet in order to increase its volume. The increase in volume is accompanied by an increase in the contact angle. The volume is increased until a contact angle plateau is reached. The value (averaged over at least 3 repetitions) of the contact angle at the plateau is referred to as the advancing angle (θₐ). The apparatus then gradually sucks the water out of the droplet, returning it to a smaller volume. Suction is continued until a contact angle plateau is reached. The value (averaged over at least there repetitions) of the contact angle at the plateau is referred to as the receding angle (θᵣ).

The hysteresis (Δθ) is the difference between the advancing and receding angles:

Δθ=θₐ−θᵣ

The aim is generally to obtain a contact angle hysteresis of the water droplet which is as low as possible.
Opel test: Standard EN 1096-2 or DIN61200

The Opel® friction test consists in rubbing the hydrophobic surface of the sample with a sheep's wool felt of hardness H1 subjected to a pressure load of 0.397 kg/cm², over an area of 1.5 cm², at a rate of 50 back-and-forth cycles per minute and a rotational speed of 6 rpm. A sample is deemed to be satisfactory when, after 5000 back-and-forth cycles, the contact angle θ is still greater than 90° and the sample is free of optical defects.

Salt corrosion resistance, measured by a test known as the Neutral Salt Spray (NSS) test, as described in standard NF ISO 9227. This test involves spraying fine droplets of neutral (pH 7) salt water (50 g/l NaCl solution) at a temperature of 35° C. and 100% relative humidity, for a period of 14 days, onto substrates inclined at 20° relative to the vertical. After 7 days, and better still at the end of the 14-day test, the contact angle should always be greater than 90° and the hysteresis less than 30°.

### Uv Resistance:

Measurement carried out using a Weather-O-Meter® equipped with a 4000 W xenon arc lamp (under the conditions of standard SAEJ 1885 or SAE-J 2527 (2004)).

The sample is continuously exposed to radiation, the spectrum of which is similar to the solar spectrum on the ground. Irradiance at a wavelength of 340 nm is 0.55 W/m²/nm.

In the context of the present application, a sample is deemed to be satisfactory if, after 1000 hours of exposure to UV radiation, the contact angle is still greater than 70° and the hysteresis is less than 30°.

### EXAMPLES

Samples of glass substrates are functionalized with different alkyltrialkoxysilanes, in the following manner:

A 10 cm×10 cm sample is cleaned by polishing using a felt impregnated with an aqueous suspension containing 20% cerium oxide particles. The polished sample is rinsed with distilled water and dried with compressed air.

To form the silica primer layer, a 0.3% solution of tetraethoxysilane (TEOS) is prepared in a mixture of isopropanol and water at pH=1 (0.1 N HCl in demineralized water). The H₂O/TEOS ratio is 500. Stirring is carried out for one hour at room temperature. The solution prepared in this way can be used for about 4 hours.

After one hour of stirring at room temperature, the solution is sprayed onto the cleaned glass sample and left to dry for about 15 minutes.

Immediately afterwards, a 3% solution of alkyltriethoxysilane in an acidic isopropanol/water mixture (0.1 N HCl, pH=1) with an H₂O/alkyltriethoxysilane molar ratio of 94.5, prepared one hour earlier and kept under mechanical stirring, is applied by spraying onto the silica primer layer thus obtained.

This is left to dry for 15 minutes at room temperature, then the excess (whitish marks) is removed by wiping with a cloth impregnated with isopropanol.

Table 1 shows the contact angle (θ) of a water droplet, the hysteresis (Δθ), salt corrosion resistance, ultraviolet (UV) resistance and abrasion resistance (Opel test) of all the samples thus prepared, compared with a sample according to the prior art prepared with a perfluoroalkyltrialkoxysilane.

TABLE 1

| | | | Salt | | | | |
|---|---|---|---|---|---|---|---|
| Alkyl chain length | θ | Δθ | corrosion | | UV | Opel test | |
| —C₁ | 91° | 17° | <2 | days | — | — | |
| —C₅ | 91° | 28° | >7 | days | >1300 h | <5000 | h |
| —C_{6 (branched)} | 103° | 29° | >7 | days | >1000 h | <5000 | h |
| —C₈ | 108° | 25° | >7 | days | >1000 h | >10000 | h |
| —C₁₀ | 105° | 20° | >14 | days | >1000 h | >10000 | h |
| —C₁₆ | 103° | 24° | >7 | days | >1000 h | >10000 | h |
| 1H,1H,2H,2H- | 103° | 36° | >7 | days | >2000 h | >10000 | h |

perfluorooctyl-

It is observed that only the glass sheets grafted with a layer of C₈-C₁₆ alkylsilanes on a silica primer layer exhibit a sufficiently durable hydrophobic nature. For shorter-chain alkylsilanes (branched C₅ and C₆), abrasion resistance is insufficient.

It should be noted that the C₁₀ alkylsilane makes it possible to obtain hydrophobic glass substrates having particularly highly durable hydrophobic properties: salt corrosion resistance of greater than 14 days and UV resistance of greater than 1000 hours.

1. A method for hydrophobicizing a glass substrate, the method comprising consecutively:
forming a primer layer on one of the main surfaces of the glass substrate,
grafting a layer of C₈-C₁₆ alkyltrialkoxysilane and/or C₈-C₁₆ alkyltrichlorosilane onto the primer layer,
optionally, a polishing step using a cloth soaked in a water/alcohol mixture containing from 30% to 90% by weight of water,
wherein the C₈-C₁₆ alkyltrialkoxysilane is a linear alkylsilane of formula CH₃ (CH₂)ₙSiR₃, where n=7-15, each R representing a C₁-3 alkoxy group, and the C₈-C₁₆ alkyltrichlorosilane is a linear alkyltrichlorosilane of formula CH₃ (CH₂)ₙSiR₃, where n=7-15, and each R representing a chlorine atom.

2. The method according to claim 1, wherein the C₈-C₁₆ alkyltrialkoxysilane is a linear alkyltrialkoxysilane of formula CH₃ (CH₂)ₙSiR₃, where n=7-11, and each R represents a C₁₋₃ alkoxy group.

3. The method according to claim 1, wherein the C₈-C₁₆ alkyltrichlorosilane is a linear alkyltrichlorosilane of formula CH₃ (CH₂)ₙSiR₃, where n=7-11, and each R represents a chlorine atom.

4. The method according to claim 1, wherein the primer layer is made of silica and that the silica primer layer is formed in a sol-gel step wherein a tetrachlorosilane and/or tetraalkoxysilane is hydrolyzed in an acidic aqueous-alcoholic medium.

5. The method according to claim 4, wherein the sol-gel step for forming the silica primer layer is carried out with an acidic aqueous-alcoholic solution containing from 0.1% to 1% by weight of tetraalkoxysilane and/or tetrachlorosilane.

6. The method according to claim 5, wherein the H₂O/tetraalkoxysilane or H₂O/tetrachlorosilane molar ratio of the acidic aqueous-alcoholic solution is between 400 and 600.

7. The method according to claim 5, wherein the aqueous-alcoholic solution of tetraalkoxysilane and/or tetrachlorosilane is left at room temperature for a period of about 30 minutes to about 4 hours, before being applied to the glass substrate by immersion, curtain coating, spraying or wiping.

8. The method according to claim 1, wherein the grafting of C₈-C₁₆ alkyltrialkoxysilane and/or C₈-C₁₆ alkyltrichlorosilane is carried out by a sol-gel step wherein the C₈-C₁₆ alkyltrialkoxysilane and/or the C₈-C₁₆ alkyltrichlorosilane is hydrolyzed in an acidic aqueous-alcoholic medium.

9. The method according to claim 8, wherein the grafting of C₈-C₁₆ alkyltrialkoxysilane and/or C₈-C₁₆ alkyltrichlorosilane is carried out with an acidic aqueous-alcoholic solution containing from 1% to 4% by weight of C₈-C₁₆ alkyltrialkoxysilane and/or C₈-C₁₆ alkyltrichlorosilane.

10. The method according to claim 9, wherein the H₂O/alkyltrialkoxysilane or H₂O/alkyltrichlorosilane molar ratio of the acidic aqueous-alcoholic solution is between 70 and 200.

11. The method according to claim 9, wherein the aqueous-alcoholic solution of C₈-C₁₆ alkyltrialkoxysilane and/or C₈-C₁₆ alkyltrichlorosilane is left at room temperature for a period of about 30 minutes to about 3 hours, before being applied, by spraying or wiping, to the glass substrate covered on one of its main faces with the silica primer layer.

12. The method according to claim 1, wherein the grafting of C₈-C₁₆ alkyltrialkoxysilane and/or C₈-C₁₆ alkyltrichlorosilane is carried out after at least 5 minutes of drying of the silica primer layer at room temperature.

13. A hydrophobic glass substrate obtained by the method according to claim 1, comprising a transparent glass substrate which is covered, on one of its main faces, with a silica primer layer, said silica primer layer being grafted with linear C₈-C₁₆ alkylsilyl groups, wherein the linear C₈-C₁₆ alkyl has a formula CH₃ (CH₂) n, where n=7-15.

14. The hydrophobic glass substrate according to claim 13, wherein n is between 7 and 11, limit values included.

15. The hydrophobic glass substrate according to claim 13, wherein the silica primer layer has a thickness of between 5 nm and 250 nm.

16. The hydrophobic glass substrate according to claim 13, wherein the hydrophobic glass substrate is a motor vehicle side window.

17. The method according to claim 1, wherein the primer layer is made of silica.

18. The method according to claim 1, wherein the C₁₋₃ alkoxy group is a methoxy or ethoxy group.

19. The method according to claim 2, wherein the C₈-C₁₆ alkyltrialkoxysilane is a linear alkyltrialkoxysilane of formula CH₃ (CH₂)ₙSiR₃, where n=7-11, and each R represents a methoxy or ethoxy group.

20. The method according to claim 4, wherein a tetraethoxysilane is hydrolyzed in an acidic aqueous-alcoholic medium.
